(19) United States
(12) Patent Application Publication
(10) Pub. No.: US 2025/0105682 A1
(43) Pub. Date: Mar. 27, 2025

(54) BRUSHLESS MOTOR FOR A POWER TOOL

(71) Applicant: MILWAUKEE ELECTRIC TOOL CORPORATION, Brookfield, WI (US)

(72) Inventors: Nikhil Gajanan RAJE, Muskego, WI (US); John C. CAMERON, Milwaukee, WI (US); Matthew N. LOMBARDO, Muskego, WI (US); Yi JIN, Dongguan City (CN)

(21) Appl. No.: 18/888,722

(22) Filed: Sep. 18, 2024

(30) Foreign Application Priority Data
Sep. 27, 2023 (CN) 202322636474.2

(51) Int. Cl. H02K 1/16; H02K 3/28; H02K 3/34; H02K 11/215

(52) U.S. Cl. CPC H02K 1/16; H02K 3/28; H02K 3/34; H02K 11/215; H02K 2203/03; H02K 2211/03

(57) ABSTRACT

A power tool includes a housing and an electric motor, the electric motor including a rotor and a stator. The rotor is coupled to a motor shaft having a spindle portion that supports an output unit. The stator includes a core, an insulator coupled to the core and including an end cap portion positioned at an axial end of the stator, and a winding forming a coil. The stator further includes a terminal configured to electrically connect the winding to a power source. The terminal is supported by the end cap portion. The terminal includes a main body portion, a tang, and a phase connection portion. The main body portion contacts the end cap portion and is generally planar and extends away from the end cap portion in an axial direction of the electric motor. The tang extends away from the main body portion in a radial direction.

### CROSS-REFERENCE TO RELATED APPLICATIONS

This application claims foreign priority to Chinese Utility Model Application No. 202322636474.2 filed on Sep. 27, 2023, now Chinese Patent No. ZL202322636474.2, the entire contents of which are incorporated herein.

### FIELD

The present disclosure relates to electric motors and, more particularly, to brushless direct-current electric motors.

### BACKGROUND

Power tools generally include a motor connected to a power source to power the tool. One such motor is a brushed direct current (“DC”) motor. In brushed DC motors, motor brushes make and break electrical connection to the motor due to rotation of the rotor. Conventionally, brushed DC motors were used in power tools for their relative ease of manufacture and low cost.

Brushed DC motors have several drawbacks when used in power tools. One drawback of brushed DC motors is that the brushes eventually wear out, reducing the longevity of the power tool. Further, because the brushes are making and breaking electrical connection, there may be sparks and electrical noise within the power tool. A brushless DC motor is another type of motor used in power tools. A brushless DC motor uses electronically controlled switches to selectively apply power to coils of a motor to drive a rotor, rather than brushes.

### SUMMARY

The present disclosure provides, in one embodiment, a power tool including a housing having a motor housing portion and a handle portion. The power tool further includes an electric motor supported within the motor housing portion and having a rotor and a stator. The rotor is coupled to a motor shaft. The motor shaft has a spindle portion that supports an output unit. The stator includes a core, an insulator coupled to the core and including an end cap portion positioned at an axial end of the stator, a winding forming a coil. The stator further includes a terminal configured to electrically connect the winding to a power source. The terminal is supported by the end cap portion. The terminal includes a main body portion, a tang, and a phase connection portion. The main body portion of the terminal contacts the end cap portion and is generally planar and extends away from the end cap portion in an axial direction of the electric motor. The tang extends away from the main body portion in a radial direction of the electric motor and bends toward the axial direction. The tang is configured to mechanically and electrically connect to the winding. The phase connection portion extends away from the main body portion in a circumferential direction that is perpendicular to the axial direction. The phase connection portion is configured to mechanically and electrically connect to a phase wire that is configured to supply power from the power source.

The present disclosure provides, in another embodiment, a power tool including a housing having a motor housing portion and a handle portion. The power tool also includes an electric motor supported within the motor housing portion and having a rotor and a stator, the rotor being coupled to a motor shaft. The stator includes a core, an insulator coupled to the core and including an end cap portion positioned at an axial end of the stator, and a winding forming a first coil and a second coil. The stator further includes a terminal configured to electrically connect the winding to a power source, the terminal being supported by the end cap portion. The terminal includes a main body portion, a tang, and a phase connection portion. The main body portion contacts the end cap portion and is generally planar and extends away from the end cap portion in an axial direction of the electric motor. The tang extends away from the main body portion in a radial direction of the electric motor and bends toward the axial direction, the tang being configured to mechanically and electrically connect to the winding. The winding comprises an elongated wire that is wound about the end cap portion to form each of the first coil and the second coil. The elongated wire further forms a crossover portion that extends about at least a portion of a circumference of the insulator to electrically connect the first coil with the second coil.

A power tool includes a housing having a motor housing portion and a handle portion. The power tool also includes an electric motor supported within the motor housing portion and having a stator, a rotor coupled to a motor shaft, and a printed circuit board assembly (PCBA). The stator includes a core, an insulator coupled to the core and including an end cap portion positioned at an axial end of the stator, and a winding forming a coil. The stator further includes a terminal configured to electrically connect the winding to a power source, the terminal being supported by the end cap portion. The terminal includes a main body portion, a tang, and a phase connection portion. The main body portion of the terminal contacts the end cap portion and is generally planar and extends away from the end cap portion in an axial direction of the electric motor. The tang extends away from the main body portion in a radial direction of the electric motor and bends toward the axial direction, the tang being configured to mechanically and electrically connect to the winding. The phase connection portion extends away from the main body portion in a circumferential direction that is perpendicular to the axial direction, the phase connection portion being configured to mechanically and electrically connect to the PCBA.

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Other aspects of the embodiments will become apparent by consideration of the detailed description and accompanying drawings.

### BRIEF DESCRIPTION OF THE DRAWINGS

FIG. 1 illustrates a side view of a power tool according to an embodiment of the disclosure.

FIG. 2 illustrates a cross-sectional view of the power tool of FIG. 1 having an electric motor according to an embodiment of the disclosure.

FIG. 3 illustrates a block diagram of a power tool, such as the power tool of FIG. 1.

FIGS. 4A and 4B illustrate perspective views of the electric motor of FIG. 2.

FIG. 4C illustrates a perspective view of portions of the electric motor of FIG. 2.

FIG. 4D illustrates an axial end view of the electric motor of FIG. 2.

FIG. 4E illustrates a detailed perspective view of a portion of the electric motor of FIG. 2.

FIG. 4F illustrates a detailed axial end view of a portion of the electric motor of FIG. 2.

FIG. 5 illustrates a method of heat staking a printed circuit board assembly (PCBA) to a stator of an electric motor, such as the electric motor of FIG. 2.

FIGS. 6A and 6B illustrate perspective views of an electric motor according to another embodiment of the disclosure.

FIG. 6C illustrates a perspective view of portions of the electric motor of FIG. 6A.

FIG. 6D illustrates a detailed perspective view of a portion of the electric motor of FIG. 6A.

FIGS. 7A and 7B illustrate perspective views of an electric motor according to another embodiment of the disclosure.

FIG. 7C illustrates a perspective view of portions of the electric motor of FIG. 7A.

FIG. 7D illustrates an axial end view of the electric motor of FIG. 7A.

FIG. 7E illustrates a detailed perspective view of a portion of the electric motor of FIG. 7A.

FIG. 7F illustrates a cross-sectional view of a portion of the electric motor of FIG. 7A, taken along line 7F-7F of FIG. 7C.

FIG. 8 illustrates a perspective view of an electric motor according to another embodiment of the disclosure.

### DETAILED DESCRIPTION

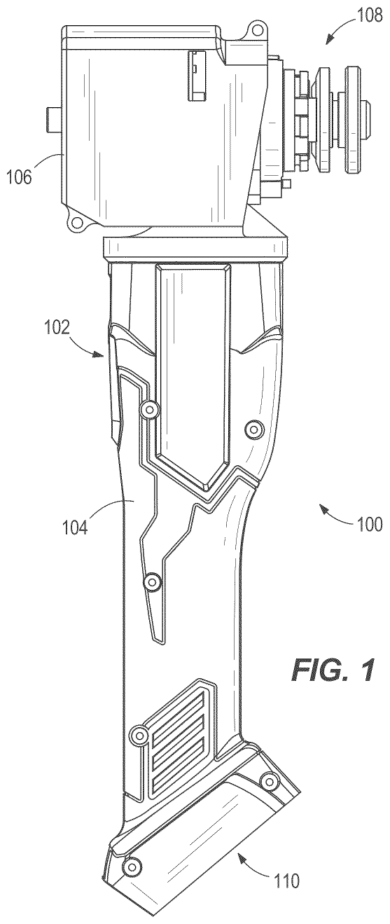

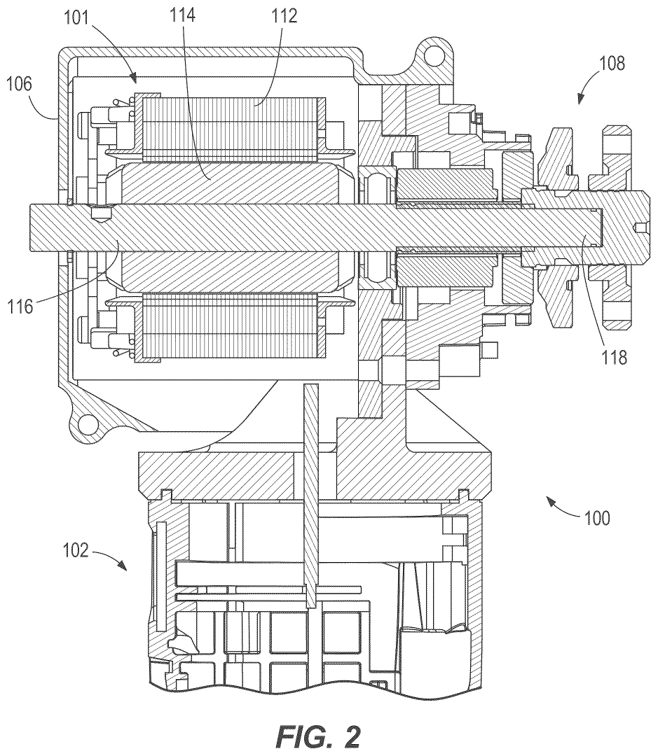

FIG. 1 illustrates a power tool 100 incorporating a brushless direct current (DC) motor 101 (FIG. 2). In a brushless motor power tool, such as power tool 100, switching elements are selectively enabled and disabled by control signals from a controller to selectively apply power from a power source (e.g., battery pack) to drive a brushless motor. The power tool 100 is illustrated as a small angle grinder having a housing 102 with a handle portion 104 and motor housing portion 106. The power tool 100 further includes an output unit 108 and a battery pack interface 110. Although FIG. 1 illustrates a small angle grinder, in some embodiments, the motors described herein are incorporated into other types of power tools including drills/drivers, impact drivers, impact wrenches, circular saws, reciprocating saws, string trimmers, leaf blowers, vacuums, and the like.

FIG. 2 shows a cross-sectional view of the power tool 100. The motor 101 is supported within the motor housing portion 106 and operatively coupled to the output unit 108. In the illustrated embodiment, the power tool 100 includes a direct drive arrangement wherein the motor 101 is directly coupled to the output unit 108 without any gear reduction assembly therebetween. The motor 101 includes a stationary stator 112 and a rotor 114 rotatably supported on a motor shaft 116. As shown in FIG. 2, the motor shaft 116 protrudes beyond an end of the rotor 114 and includes a spindle portion 118 that supports the output unit 108.

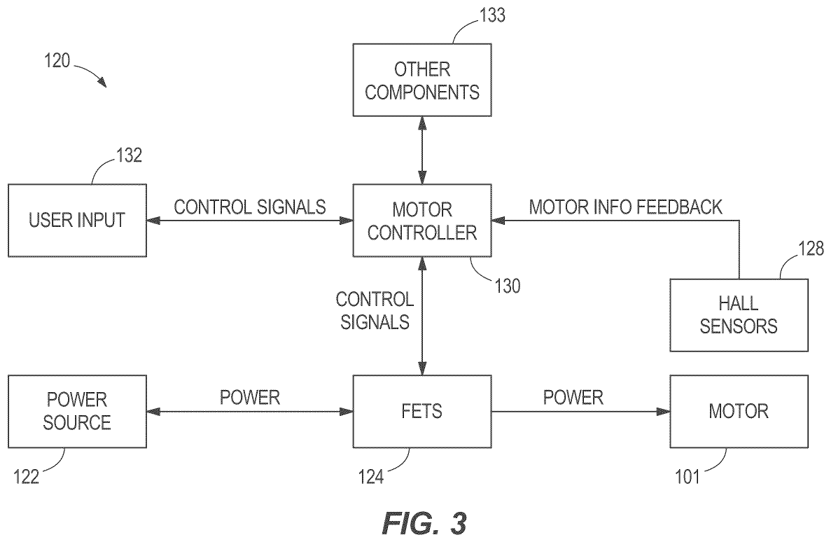

FIG. 3 illustrates a simplified block diagram 120 of the power tool 100, which includes a power source 122, Field Effect Transistors (FETs) 124, the motor 101, Hall effect sensors 128, a motor controller 130, user input 132, and other components 133 (battery pack fuel gauge, work lights (LEDs), current/voltage sensors, etc.). The power source 122 provides DC power to the various components of the power tool 100 and may be a power tool battery pack that is rechargeable and uses, for instance, lithium ion cell technology. In some instances, the power source 122 may receive AC power (e.g., 120V/60 Hz) from a tool plug that is coupled to a standard wall outlet, and then filter, condition, and rectify the received power to output DC power. Each Hall effect sensor 128 outputs motor feedback information, such as an indication (e.g., a pulse) when a magnet of the rotor 114 rotates across the face of that Hall sensor. Based on the motor feedback information from the Hall sensors 128, the motor controller 130 can determine the position, velocity, and acceleration of the rotor 114. The motor controller 130 also receives user controls from user input 132, such as by activating an on/off switch (not shown). In response to the motor feedback information and user controls, the motor controller 130 transmits control signals to control the FETs 124 to drive the motor 101. By selectively enabling and disabling the FETs 124, power from the power source 122 is selectively applied to stator coils of the motor 101 to cause rotation of the rotor 114. Although not shown, the motor controller 130 and other components of the power tool 100 are electrically coupled to the power source 122 such that the power source 122 provides power thereto.

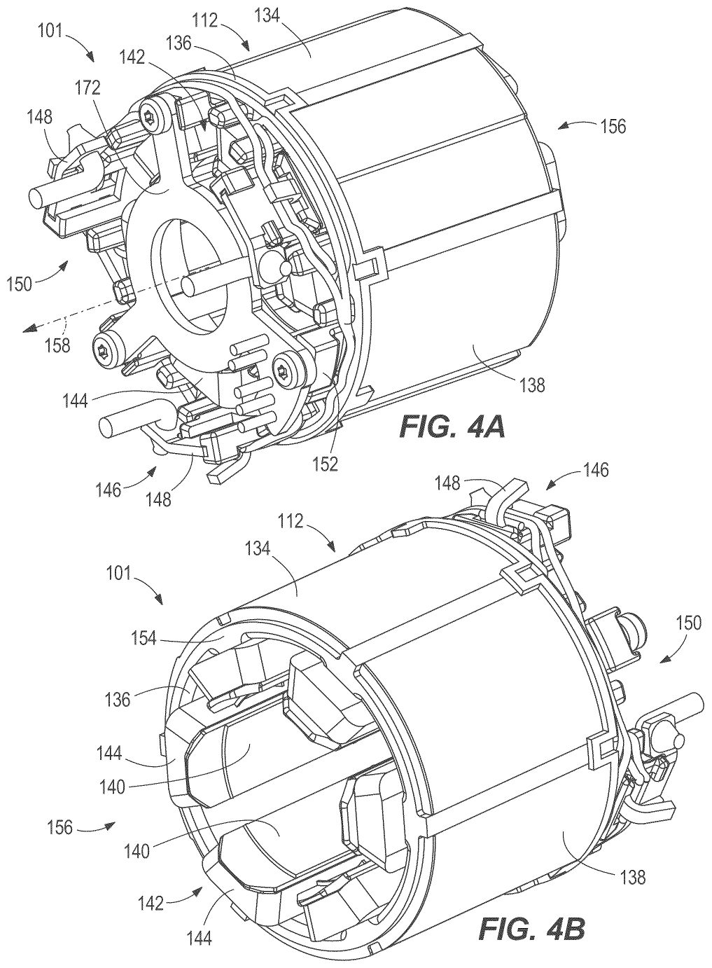

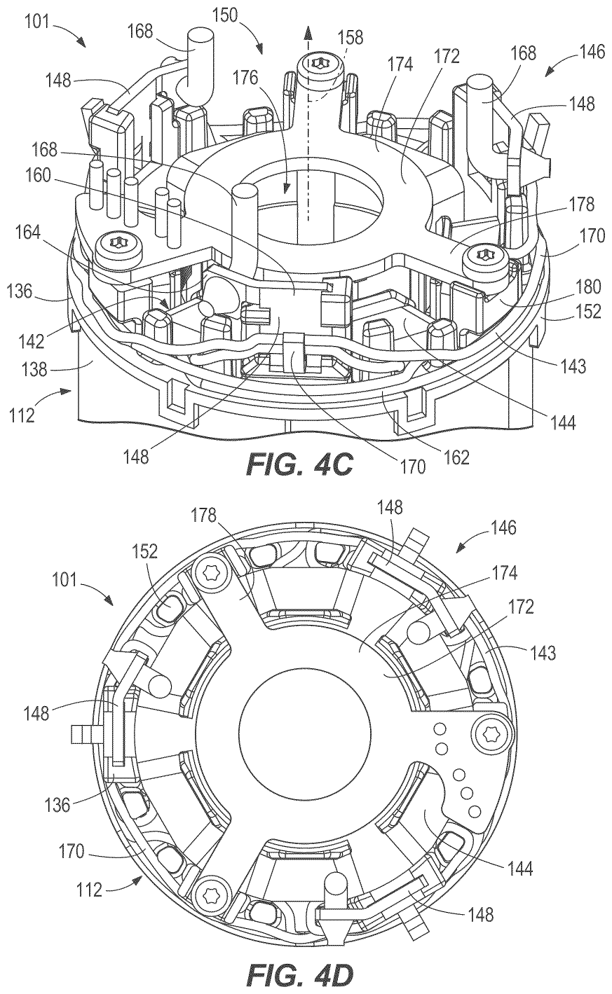

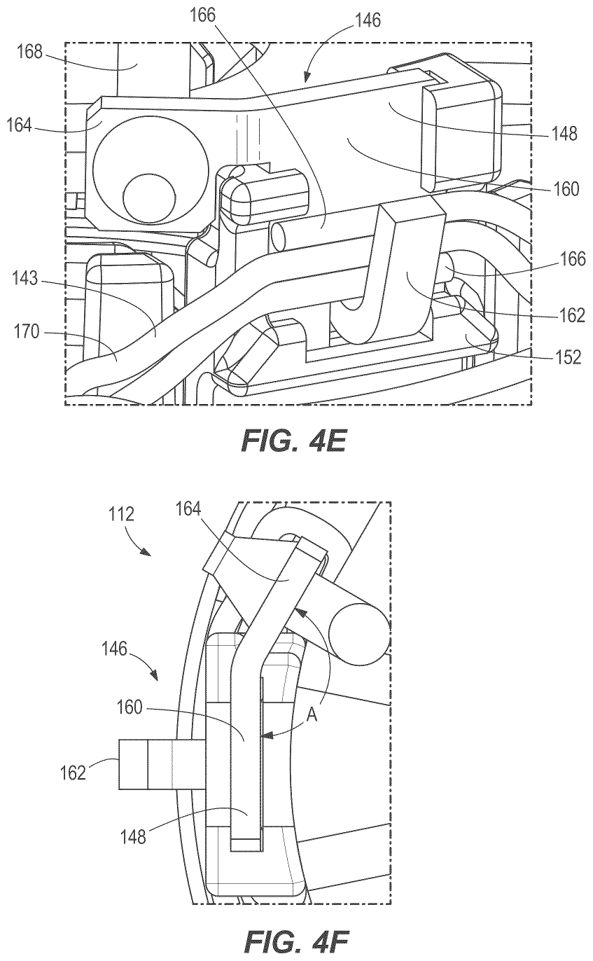

Various embodiments of the motor 101 are illustrated and described with respect to FIGS. 4A-7D.

FIGS. 4A-4F further illustrate the motor 101 according to one embodiment. The stator 112 includes a stator core 134 and an insulator 136 affixed to the stator core 134. In some embodiments, the stator core 134 can be formed as a lamination stack having a plurality of thin flat laminations stacked together along an axial direction of the stator core 134. The stator core 134 includes an annular yoke 138 and a plurality of teeth 140 (e.g., six teeth in the illustrated embodiment) protruding inward radially from the yoke 138. Windings 142 are wound about the teeth 140 to form coils 144. In some embodiments, the windings 142 can be formed entirely from a single insulated wire 143 that is wrapped about the teeth 140 to form all of the coils 144. The windings 142 are electrically insulated from the stator core 134 by the insulator 136. In some embodiments, the insulator 136 can be formed from resin by injection molding.

With reference to FIGS. 4A-4C, the motor 101 also includes a terminal assembly 146 including a plurality of terminals 148 for electrically interconnecting the coils 144 in a winding arrangement. In the illustrated embodiment, the terminal assembly 146 includes three terminals 148 that are each supported by the insulator 136 at a first axial end 150 of the motor 101. More specifically, the insulator 136 includes a first end cap portion 152 located at the first axial end 150 and a second end cap portion 154 located at an opposite second axial end 156, and the terminals 148 are supported on the first end cap portion 152. The terminals 148 are spaced apart from one another about a longitudinal axis 158 of the motor 101. In the illustrated embodiment, the terminals 148 are spaced apart from one another at equal angular intervals of approximately 120 degrees.

With reference to FIGS. 4C-4F, each terminal 148 includes a main body portion 160, a winding connection portion or tang 162, and a phase connection portion 164. The main body portion 160 of each terminal 148 is generally flat (i.e., planar) and spans generally in an axial direction and generally in a circumferential direction in its longest dimensions. The tang 162 of each terminal 148 is generally elongated and bent in a hook-shape. The tang 162 extends radially outward from the main body portion 160 and then bends away from the insulator 136 and toward the axial direction. The phase connection portion 164 of each terminal 148 extends laterally away from the main body portion 160 in generally a circumferential direction of the motor 101. The phase connection portion 164 is also generally flat (i.e., planar), and extends away from the main body portion 160 in a direction (e.g., a lateral direction) that is perpendicular to the axial direction and perpendicular to the longitudinal axis 158. This reduces an overall length of the motor 101 because phase connection portion 164 does not protrude axially beyond the main body portion 160. The phase connection portion 164 is also generally flat (i.e., planar) and defines an obtuse angle A with respect to the main body portion 160. In the illustrated embodiment, the angle A is approximately 150 degrees. In some embodiments, the obtuse angle A can be greater than 90 degrees and less than 180 degrees. In further embodiments, the obtuse angle A can be greater than 110 degrees and less than 170 degrees, so that the phase connection portion 164 bends toward the curvature of the stator 112 and generally remains within a footprint or projected area of the stator 112. The angle A reduces an overall diameter of the motor 101 because the phase connection portion 164 does not protrude radially beyond a circumferential outer surface of the stator 112, but rather follows the curvature of the yoke 138.

With reference to FIGS. 4C-4F, the windings 142 are mechanically and electrically connected to the terminals 148. Specifically, the windings 142, which are formed of a single elongated wire 143 in the illustrated embodiment, include a pair of wire ends or leads 166 that connect to the tang 162 of at least one terminal 148. The windings 142 are further connected to the tangs 162 of each of the terminals 148 at various midpoints along their length between at least two respective coils 144. In some embodiments, the windings 142 (i.e., the wire leads or other portions of the wire 143) are soldered, resistance welded, or fused to the tangs 162. The phase connection portions 164 are connected to corresponding phase wires 168 (e.g., corresponding to U, V, and W phases) by, e.g., soldering, resistance wilding, or fusing. In the illustrated embodiment, each phase connection portion 164 defines an aperture that receives an end of the corresponding phase wire 168, which is fixed to the phase connection portion 164 by soldering. As such, the terminals 148 electrically connect the phase wires 168 to the coils 144 to supply power thereto. The stator coils 144 are selectively energized by the power source 122 via the FETs 124, for example. In the illustrated embodiment, the stator coils 144 include three phases (i.e., U, V, and W phases). The three phases of the stator coils 144 can be connected to each other in a delta, wye, or any other suitable configuration.

The windings 142 further include crossover portions 170 that extend circumferentially about portions of the insulator 136. More specifically, the crossover portions 170 are routed about portions of the first end cap portion 152 of the insulator 136. In the illustrated embodiment, the crossover portions 170 extend to electrically connect at least two different coils 144 that are located geometrically opposite one another with respect to the longitudinal axis 158. Others of the crossover portions 170 also extend to connect between a respective coil 144 and a distantly located respective terminal 148. The crossover portions 170 facilitate the winding configuration of the stator 112 (e.g., delta, wye, or other suitable configurations). Notably, the crossover portions 170 are located at the first axial end 150 of the motor 101 in the illustrated embodiment, as are the terminals 148.

With reference to FIG. 4C, the motor 101 further includes a printed circuit board assembly (PCBA) 172 coupled to the stator 112 at the first axial end 150. The PCBA supports the Hall effect sensors 128 (FIG. 3). The PCBA 172 includes a central ring 174 that defines a central through hole 176, and a plurality of arms 178 protruding radially outward from the central ring 174. The arms 178 are attached to the first end cap portion 152 of the insulator 136. More specifically, the first end cap portion 152 includes a plurality of mounting portions 180 extending axially outward and corresponding in number to the arms 178. In the illustrated embodiment, each arm 178 is attached to the corresponding mounting portion 180 via a screw. In other embodiments, the arms 178 can be connected to the mounting portions 180 by alternative means as discussed below.

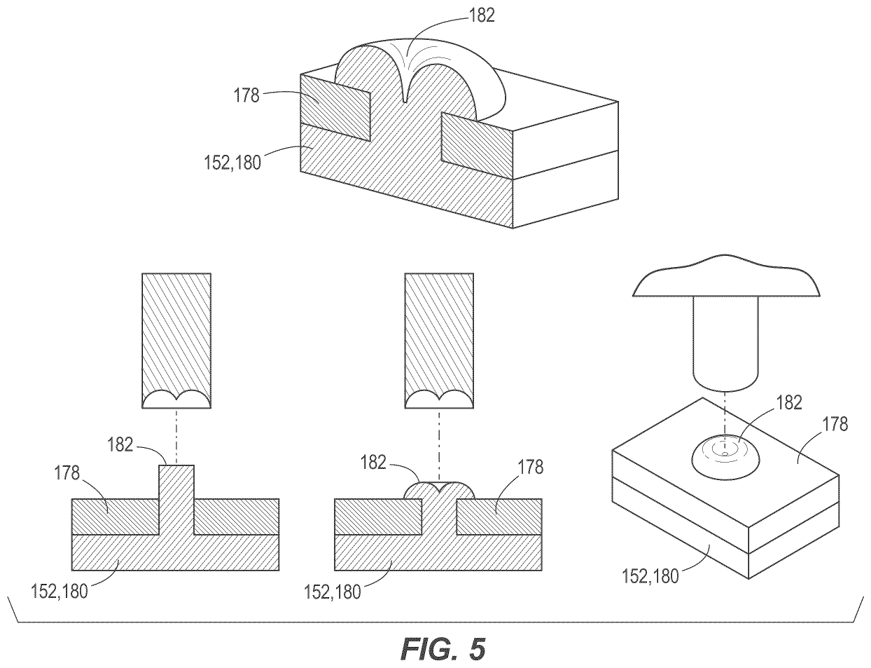

FIG. 5 illustrates a heat staking method for securing the arms 178 to the mounting portions 180 of the first end cap portion 152 according to another embodiment. During the heat staking method, an axially protruding stake or post 182 extending from the mounting portion 180 of the insulator 136 is pressed into an aperture formed in the arm 178 of the PCBA 172. The post 182 is formed having an axial length greater than an axial length of the aperture, i.e., greater than a width of the arm 178, so that an end portion of the post 182 protrudes beyond a rim of the aperture. The end portion of the post 182 is then heated until partially melted to form a dome or rivet over the rim of the aperture. This provides a secure mechanical connection between the insulator 136 and the PCBA 172.

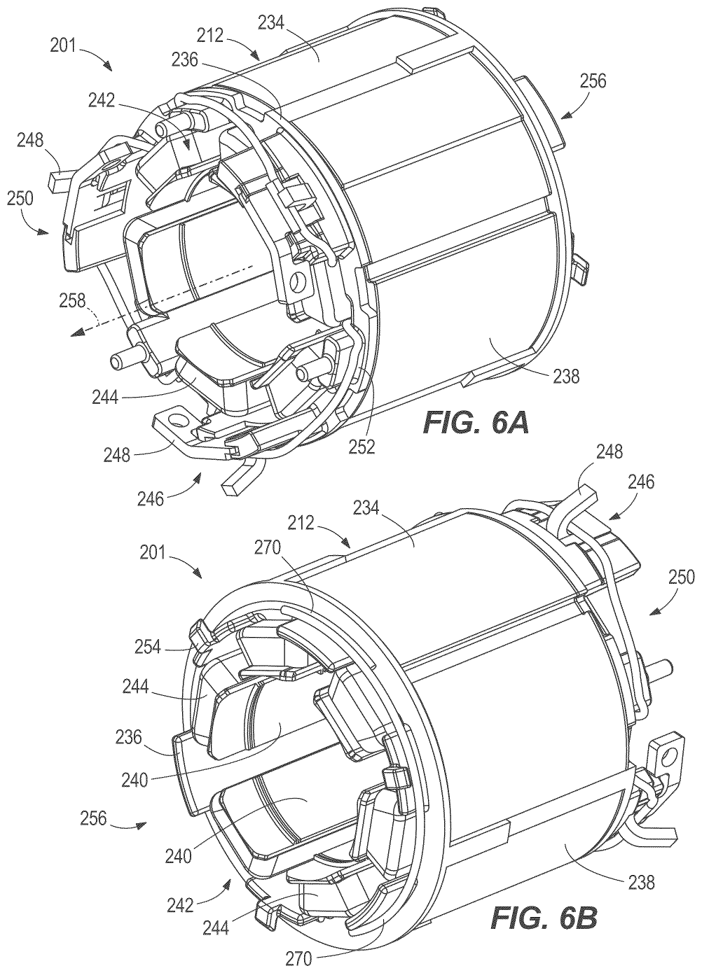

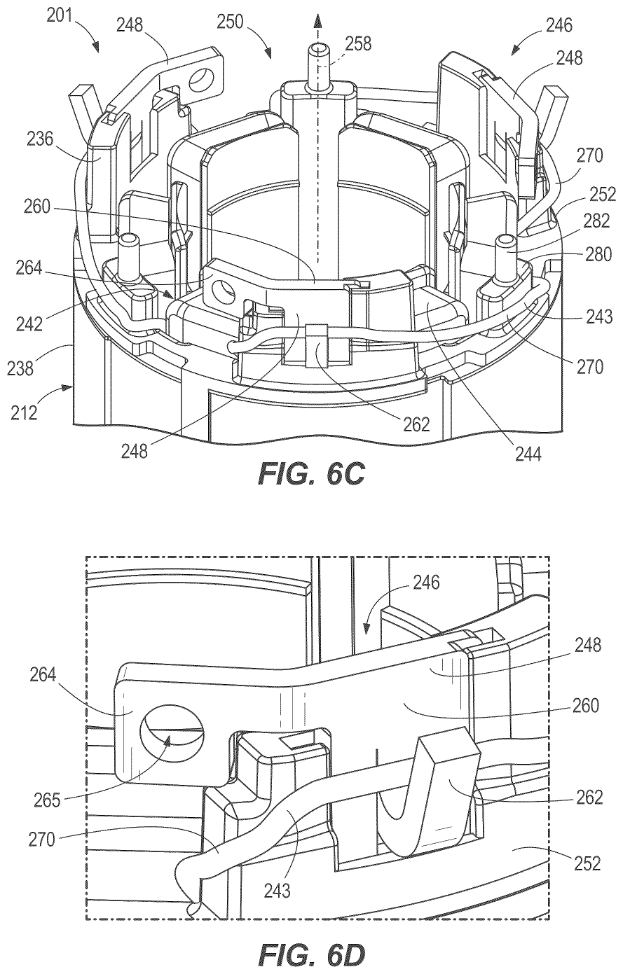

FIGS. 6A-6D illustrate an embodiment of a motor 201 like the motor 101 described above, with like features shown with like reference numerals plus “100,” unless explained differently below. The motor 201 includes a stator 212 that is substantially similar to the stator 112 described above, except for the differences that are described hereafter. The stator 212 is operable with the rotor 114 described above with respect to FIG. 2, such that the motor 201 may include the rotor 114. The motor 201 can likewise be utilized in the power tool 100 (FIGS. 1 and 2) described above, and is further operable with the power source 122, the FETs 124, the Hall effect sensors 128, the motor controller 130, the user input 132, and the other components 133 described above with respect to FIG. 3.

The stator 212 includes a core 234, an insulator 236, windings 242, and a terminal assembly 246. The core 234 includes a yoke 238 and a plurality of teeth 240. The windings 242 are wound about the teeth 240 to form coils 244. In some embodiments, the windings 242 can be formed entirely from a single insulated wire 243 that is wrapped about the teeth 240 to form all of the coils 244. The insulator 236 includes a first end cap portion 252 located at a first axial end 250 of the motor 201 and a second end cap portion 254 located at an opposite second axial end 256.

With reference to FIGS. 6C-6D, the terminal assembly 246 includes a plurality of terminals 248 for electrically interconnecting the coils 244 in a winding arrangement. The terminals 248 are substantially similar to the terminals 148 described above, and are supported by the first end cap portion 252 in a substantially similar manner and arrangement as that described for the motor 101. Specifically, each terminal 248 includes a main body portion 260, a winding connection portion or tang 262, and a phase connection portion 264. The phase connection portion 264 defines an aperture 265 that receives an end of the corresponding phase wire (not shown, but see FIG. 4E showing phase wire 168). The main body portion 260, however, has a shorter axial length than that of the main body portion 160 of the terminals 148. Stated differently, the main body portion 260 has a shorter length in an axial direction of the motor 201, or in a direction of the longitudinal axis 258, than that of the main body portion 160 described above, for the reasons explained herein.

The windings 242 further include crossover portions 270 that extend circumferentially about portions of the insulator 236. As shown in FIG. 6C, some of the crossover portions 270 are routed about portions of the first end cap portion 252 to connect at least some of the coils 244 to the terminals 248. As shown in FIG. 6B, others of the crossover portions 270 are extend about portions of the second end cap portion 254 (i.e., at the second axial end 256) to electrically connect at least two different coils 244 located geometrically opposite one another with respect to the longitudinal axis 258. The crossover portions 270 facilitate the winding configuration of the stator 212 (e.g., delta, wye, or other suitable configurations). Since at least some of the crossover portions 270 are located at the second axial end 256 of the motor 201 in the illustrated embodiment, relatively fewer crossover portions 270 are located at the first axial end 250 as compared to the motor 101. As such, relatively less space is required to accommodate the crossover portions 270 at the first axial end 250. This arrangement of the crossover portions 270 permits the length of the main body portions 260 of the terminals 248 to be shortened as described above, which generally results in a shortened overall axial length of the motor 201 as compared to the motor 101. The shorter length of the motor 201 is advantageous because, for example, the motor 201 will occupy relatively less space within the motor housing portion 106 of the power tool 100, and the size of the power tool 100 can accordingly be reduced.

With reference to FIG. 6C, the motor 201 also includes mounting portions 280 for coupling the PCBA 172 (FIG. 4C) to the stator 212. The mounting portions 280 differ from the mounting portions 180 (FIG. 4C) described herein, because the mounting portions 280 include axially extending posts 282 for affixing the PCBA 172 to the stator 212 by heat staking (see FIG. 5 and corresponding description herein). Because the PCBA 172 is heat staked to the mounting portions 280, the mounting portions 280 do not include a threaded bore for receiving screws, which reduces an axial length of the mounting portions 280 as compared to the mounting portions 180. Thus, an overall axial length of the motor 201 is further reduced as compared to the motor 101.

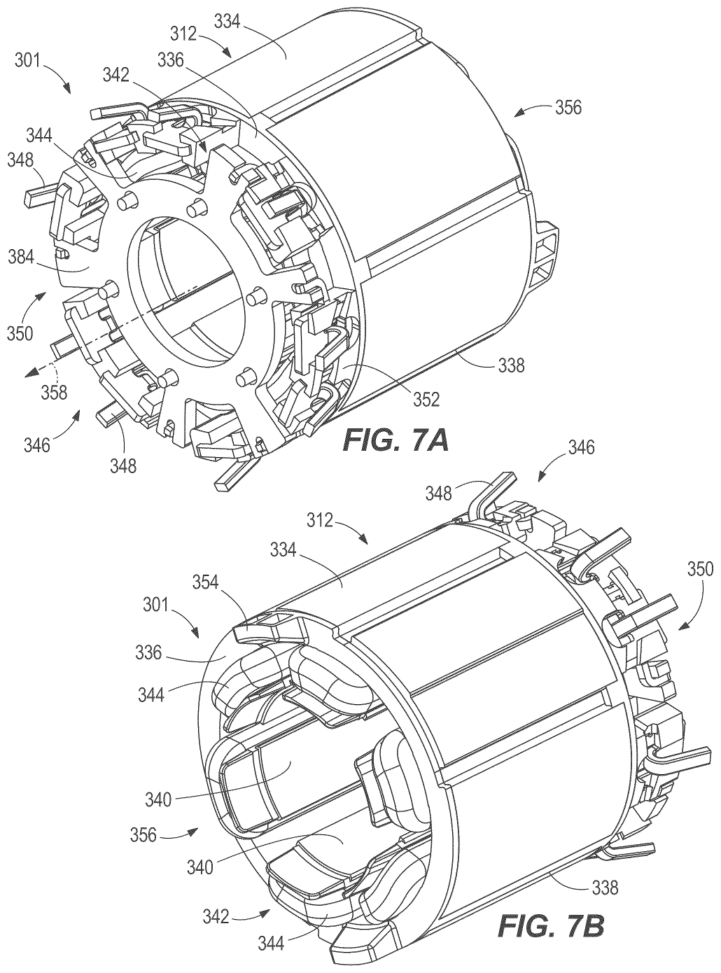

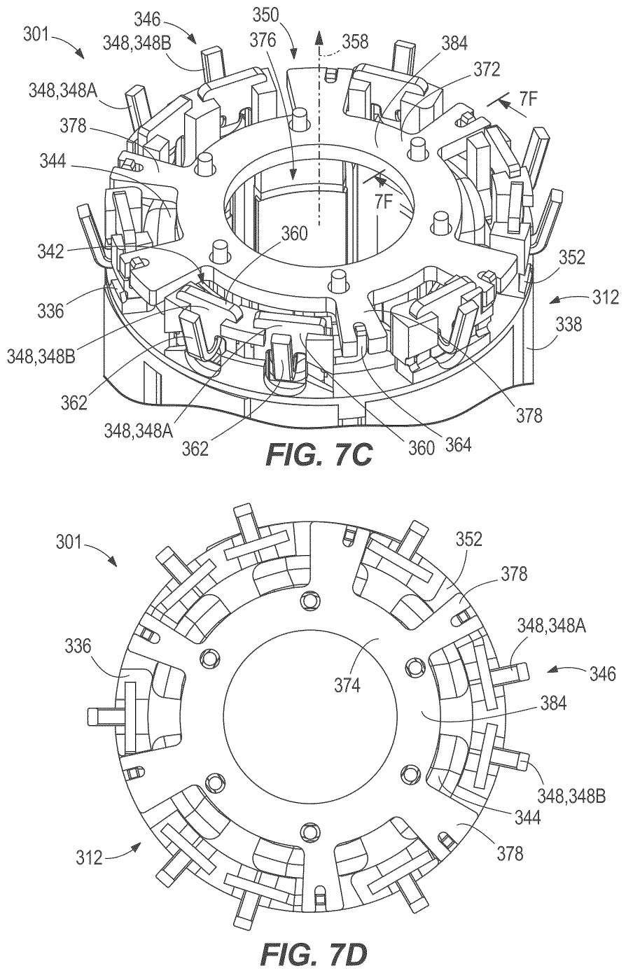

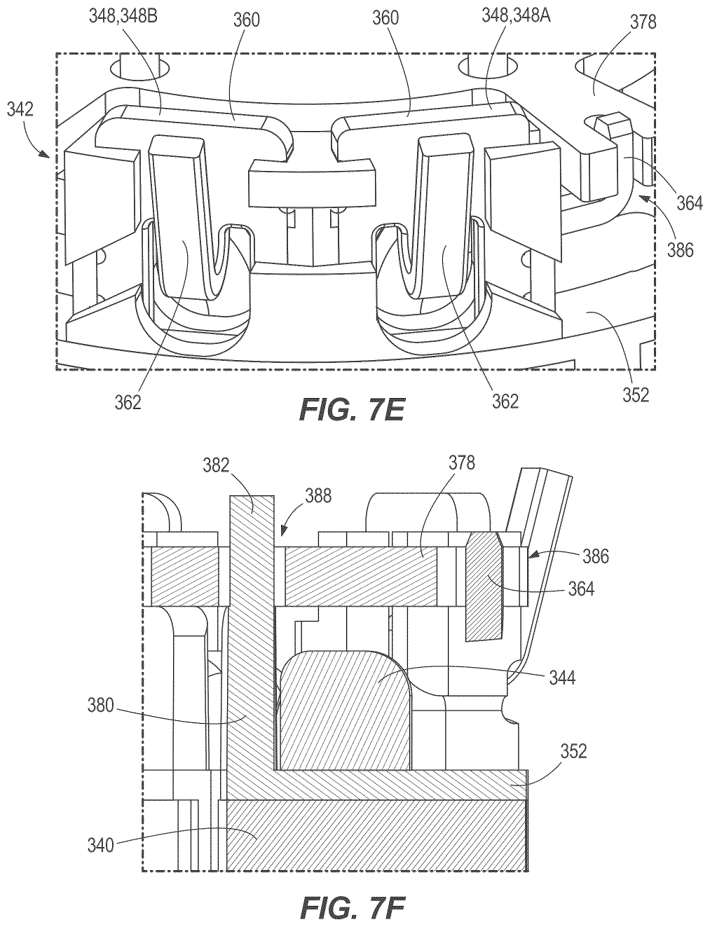

FIGS. 7A-7F illustrate an embodiment of a motor 301 like the motor 101 described above, with like features shown with like reference numerals plus “200,” unless explained differently below. The motor 301 includes a stator 312 that is substantially similar to the stator 112 described above, except for the differences that are described hereafter. The stator 312 is operable with the rotor 114 described above with respect to FIG. 2, such that the motor 301 may include the rotor 114. The motor 301 can likewise be utilized in the power tool 100 (FIGS. 1 and 2) described above, and is further operable with the power source 122, the FETs 124, the Hall effect sensors 128, the motor controller 130, the user input 132, and the other components 133 described above with respect to FIG. 3.

With reference to FIGS. 7A-7D, the stator 312 includes a core 334, an insulator 336, windings 342, and a terminal assembly 346. The core 334 includes a yoke 338 and a plurality of teeth 340. The windings 342 are wound about the teeth 340 to form coils 344. In some embodiments, the windings 342 can be formed entirely from a single insulated wire (not shown) that is wrapped about the teeth 340 to form all of the coils 344, or, in other embodiments, the windings 342 may include two or more separate wires that form the coils 344. The insulator 336 includes a first end cap portion 352 located at a first axial end 350 of the motor 301 and a second end cap portion 354 located at an opposite second axial end 356.

With reference to FIGS. 7C-7E, the terminal assembly 346 includes a plurality of terminals 348, including some phase connection terminals 348A and some winding connection terminals 348B, for electrically interconnecting the coils 344 in a winding arrangement. The terminals 348A are similar to the terminals 148 described above, and are supported by the first end cap portion 352. There are six terminals 348A in the illustrated embodiment. Each terminal 348A includes a main body portion 360, a winding connection portion or tang 362, and a phase connection portion 364. The phase connection portion 364 differs somewhat from the phase connection portion 164 described herein and does not directly connect to a phase wire (not shown, but see FIG. 4E showing phase wire 168). Instead, the phase connection portion 364 connects to a PCBA 384 as will be further described. The terminals 348B are also similar to the terminals 148 described above, and are supported by the first end cap portion 352, but the terminals 348B do not include a phase connection portion. There are three terminals 348B in the illustrated embodiment. The terminals 348B only form connections between different coils 344, and do not directly connect to the phase wires.

The PCBA 384 differs from the PCBA 172 described above, and functions to connect the coils 344 to the phase wires. And, in at least some embodiments, the PCBA 384 supports the Hall effect sensors 128 (FIG. 3). The PCBA 384 includes a central ring 374 that defines a central through hole 376, and a plurality of arms 378 protruding radially outward from the central ring 374. The PCBA 384 includes six arms 378 in the illustrated embodiment, with each arm 378 corresponding to a phase connection portion 364 of a corresponding terminal 348A. Each arm 378 defines a notch 386 at its distal end that receives the phase connection portion 364 of the corresponding terminal 348A, which is then soldered to the PCBA 384 (e.g., to a conductive pad located at the notch 386). The PCBA 384 further includes conductive traces (not shown) that electrically connect the terminals 348A to the phase wires to form the particular winding configuration of the stator 312 (e.g., delta, wye, or other suitable configurations). That is, the phase wires (not shown) connect to the PCBA 384 rather than to the terminals 348. Thus, the motor 301 does not include (or, includes relatively fewer) crossover portions, which allows an overall length of the motor 301 to be shortened as compared to the motor 101.

With reference to FIGS. 7C and 7F, the motor 301 also includes mounting portions 380 for coupling the PCBA 384 to the stator 312. The mounting portions 380 differ from the mounting portions 180 (FIG. 4C) described herein because the mounting portions 380 are located at radially inner portions of the teeth 340. The mounting portions 380 include axially extending posts 382 for affixing the PCBA 384 to the stator 312 by heat staking (sec FIG. 5 and corresponding description herein). The central ring 374 of the PCBA 384 includes a plurality of apertures 388 corresponding to and receiving the posts 382. Because the PCBA 384 is heat staked to the mounting portions 380, the mounting portions 380 do not include a threaded bore for receiving screws, which reduces an axial length of the mounting portions 380 as compared to the mounting portions 180. Thus, an overall axial length of the motor 301 is further reduced as compared to the motor 101.

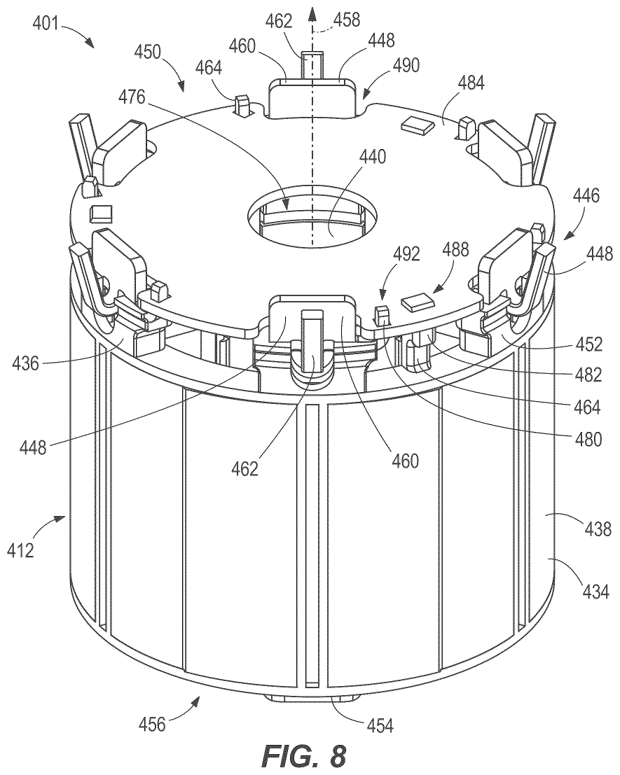

FIG. 8 illustrates an embodiment of a motor 401 like the motor 301 described above, with like features shown with like reference numerals plus “100,” unless explained differently below. The motor 401 includes a stator 412 that is substantially similar to the stator 312 described above, except for the differences that are described hereafter. The stator 412 is operable with the rotor 114 described above with respect to FIG. 2, such that the motor 401 may include the rotor 114. The motor 401 can likewise be utilized in the power tool 100 (FIGS. 1 and 2) described above, and is further operable with the power source 122, the FETs 124, the Hall effect sensors 128, the motor controller 130, the user input 132, and the other components 133 described above with respect to FIG. 3.

The stator 412 includes a core 434, an insulator 436, windings (not shown), and a terminal assembly 446. The core 434 includes a yoke 438 and a plurality of teeth 440. The windings are wound about the teeth 440 to form coils (not shown). In some embodiments, the windings can be formed entirely from a single insulated wire that is wrapped about the teeth 440 to form all of the coils, or, in other embodiments, the windings may include two or more separate wires that form the coils. The insulator 436 includes a first end cap portion 452 located at a first axial end 450 of the motor 401 and a second end cap portion 454 located at an opposite second axial end 456.

The terminal assembly 446 includes a plurality of terminals 448, which are all phase connection terminals, for electrically interconnecting the coils in a winding arrangement. The terminals 448 are similar to the terminals 348A described above, and are supported by the first end cap portion 452. There are six terminals 448 in the illustrated embodiment. Each terminal 448 includes a main body portion 460, a winding connection portion or tang 462, and a phase connection portion 464. The phase connection portion 464 connects to a PCBA 484 as will be further described.

The PCBA 484 functions to connect the coils to the phase wires. And, in at least some embodiments, the PCBA 484 supports the Hall effect sensors 128 (FIG. 3). The PCBA 484 is generally circular and shaped as a flat disk, and defines a central through hole 476. The PCBA 484 includes, in the illustrated embodiment, six first notches 490 defined in its radially outer periphery at intervals and each accommodating a respective main body portion 460 of a corresponding terminal 448. The PCBA 484 also includes six through holes 492, with each through hole 492 located adjacent a corresponding first notch 490. The through holes 492 correspond to the phase connection portion 464 of the terminal 448. Each through hole 492 receives the phase connection portion 464 of the corresponding terminal 448, which is then soldered to the PCBA 484 (e.g., to a conductive pad located at the through hole 492). The PCBA 484 further includes conductive traces (not shown) that electrically connect the terminals 448 to the phase wires to form the particular winding configuration of the stator 412 (e.g., delta, wye, or other suitable configurations). That is, the phase wires (not shown) connect to the PCBA 484 rather than to the terminals 448 themselves. Thus, the motor 401 does not include (or, includes relatively fewer) crossover portions, which allows an overall length of the motor 401 to be shortened as compared to the motor 101.

The motor 401 also includes mounting portions 480 for coupling the PCBA 484 to the stator 412. The mounting portions 480 are on the first end cap portion 452 and include axially extending posts 482 for affixing the PCBA 484 to the stator 412 by heat staking (see FIG. 5 and corresponding description herein). The PCBA 484 includes a plurality of apertures 488 corresponding to and receiving the posts 482. Because the PCBA 484 is heat staked to the mounting portions 480, the mounting portions 480 do not include a threaded bore for receiving screws, which reduces an axial length of the mounting portions 480 as compared to the mounting portions 180. Thus, an overall axial length of the motor 401 is further reduced as compared to the motor 101.

Although the disclosure has been described in detail with reference to certain preferred embodiments, variations and modifications exist within the scope and spirit of one or more independent aspects of the disclosure as described. Various features and/or advantages of the disclosure are set forth in the following claims.

1. A power tool comprising:
a housing having a motor housing portion and a handle portion;
an electric motor supported within the motor housing portion and having a rotor and a stator, the rotor being coupled to a motor shaft, the motor shaft having a spindle portion that supports an output unit;
wherein the stator includes
a core,
an insulator coupled to the core and including an end cap portion positioned at an axial end of the stator,
a winding forming a coil, and
a terminal configured to electrically connect the winding to a power source, the terminal being supported by the end cap portion and including a main body portion, a tang, and a phase connection portion;
wherein the main body portion of the terminal contacts the end cap portion and is generally planar and extends away from the end cap portion in an axial direction of the electric motor;
wherein the tang extends away from the main body portion in a radial direction of the electric motor and bends toward the axial direction, the tang being configured to mechanically and electrically connect to the winding; and
wherein the phase connection portion extends away from the main body portion in a circumferential direction that is perpendicular to the axial direction, the phase connection portion being configured to mechanically and electrically connect to a phase wire that is configured to supply power from the power source.

2. The power tool of claim 1, wherein the phase connection portion is generally planar and forms an obtuse angle with the main body portion.

3. The power tool of claim 2, wherein the obtuse angle is between 110 degrees and 170 degrees.

4. The power tool of claim 1, wherein the phase connection portion defines an aperture configured to receive a wire end of the phase wire.

5. The power tool of claim 1, wherein:
the coil is a first coil, and the stator further comprises a second coil located opposite from the first coil with respect to a longitudinal axis of the of the electric motor; and
the winding comprises an elongated wire that is wound about the insulator to form each of the first coil and the second coil, the elongated wire further forming a crossover portion that extends about at least a portion of a circumference of the end cap portion to electrically connect the first coil with the second coil.

6. The power tool of claim 5, wherein the crossover portion is located at the axial end of the stator.

7. The power tool of claim 5, wherein:
the axial end of the stator is a first axial end and the end cap portion is a first end cap portion;
the insulator further includes a second end cap portion positioned at a second axial end of the stator located opposite from the first axial end; and
the crossover portion is located at the second axial end.

8. The power tool of claim 1, wherein the electric motor further comprises a printed circuit board assembly (PCBA), and wherein the end cap portion includes a post that extends axially through an aperture defined in the PCBA, the post being configured to secure the PCBA to the end cap portion.

9. A power tool comprising:
a housing having a motor housing portion and a handle portion;
an electric motor supported within the motor housing portion and having a rotor and a stator, the rotor being coupled to a motor shaft;
wherein the stator includes
a core,
an insulator coupled to the core and including a first end cap portion positioned at a first axial end of the stator and a second end cap portion positioned at a second axial end of the stator located opposite from the first axial end,
a winding forming a first coil and a second coil, and
a terminal configured to electrically connect the winding to a power source, the terminal being supported by the first end cap portion and including a main body portion, a tang, and a phase connection portion;
wherein the main body portion contacts the first end cap portion and is generally planar and extends away from the first end cap portion in an axial direction of the electric motor;
wherein the tang extends away from the main body portion in a radial direction of the electric motor and bends toward the axial direction, the tang being configured to mechanically and electrically connect to the winding; and
wherein the winding comprises an elongated wire that is wound about the insulator to form each of the first coil and the second coil, the elongated wire further forming a crossover portion that extends about at least a portion of a circumference of the second end cap portion at the second axial end to electrically connect the first coil with the second coil.

10. The power tool of claim 9, wherein the phase connection portion extends away from the main body portion in a circumferential direction that is perpendicular to the axial direction, the phase connection portion being configured to mechanically and electrically connect to a phase wire that is configured to supply power from the power source.

11. The power tool of claim 10, wherein the phase connection portion is generally planar and forms an obtuse angle with the main body portion.

12. The power tool of claim 11, wherein the obtuse angle is between 110 degrees and 170 degrees.

13. (canceled)

14. The power tool of claim 9, wherein the electric motor further comprises a printed circuit board assembly (PCBA), and wherein the first end cap portion includes a post that extends axially through an aperture defined in the PCBA, the post being configured to secure the PCBA to the first end cap portion.

15. A power tool comprising:
a housing having a motor housing portion and a handle portion;
an electric motor supported within the motor housing portion and having a stator, a rotor coupled to a motor shaft, and a printed circuit board assembly (PCBA);
wherein the stator includes
a core,
an insulator coupled to the core and including an end cap portion positioned at an axial end of the stator,
a winding forming a coil, and
a terminal configured to electrically connect the winding to a power source, the terminal being supported by the end cap portion and including a main body portion, a tang, and a phase connection portion;
wherein the main body portion of the terminal contacts the end cap portion and is generally planar and extends away from the end cap portion in an axial direction of the electric motor;
wherein the tang extends away from the main body portion in a radial direction of the electric motor and bends toward the axial direction, the tang being configured to mechanically and electrically connect to the winding; and
wherein the phase connection portion extends away from the main body portion in a circumferential direction that is perpendicular to the axial direction, the phase connection portion being configured to mechanically and electrically connect to the PCBA.

16. The power tool of claim 15, wherein the coil is a first coil, and the stator further comprises a second coil, and wherein the PCBA electrically connects the first coil with the second coil.

17. The power tool of claim 16, wherein the PCBA includes a central ring and an arm protruding radially outward from the central ring, and wherein the arm defines a connection notch that receives the phase connection portion.

18. The power tool of claim 16, wherein the PCBA defines a terminal notch that receives the main body portion.

19. The power tool of claim 15, wherein the end cap portion includes a post that extends axially through an aperture defined in the PCBA, the post being configured to secure the PCBA to the end cap portion.

20. The power tool of claim 15, wherein the PCBA includes a Hall-effect sensor.
